(19) United States
(12) Patent Application Publication
(10) Pub. No.: US 2025/0102480 A1
(43) Pub. Date: Mar. 27, 2025

(54) GAS-PHASE ANALYTICAL SYSTEM COMPRISING AN OPTICAL DETECTION DEVICE

(71) Applicant: COMMISSARIAT A L’ENERGIE ATOMIQUE ET AUX ENERGIES ALTERNATIVES, PARIS (FR)

(72) Inventors: Bertrand BOURLON, GRENOBLE (FR); Loïc LAPLATINE, GRENOBLE (FR); Pomme HIRSCHAUER, GRENOBLE (FR)

(21) Appl. No.: 18/818,032

(22) Filed: Aug. 28, 2024

(30) Foreign Application Priority Data
Sep. 22, 2023 (FR) 2310040

(51) Int. Cl. G01N 30/74; B01D 53/02; G01N 30/02

(52) U.S. Cl. CPC G01N 30/74; B01D 53/025; G01N 2030/025

(57) ABSTRACT

A gas-phase analytical system including an injection unit configured to inject a sample to be analyzed including at least one chemical compound, a unit for introducing a stream of carrier gas, a transport column, and a detection device, the chemical compound(s) being entrained by the gas into the column up to the device. The device is an optical detector including at least one Mach-Zehnder interferometric sensor supplied by an optical source and integrated into a microfluidic structure, the sensor comprising a sensing arm exposed to the chemical compound(s) and a reference arm impermeable to the chemical compound(s), the sensor(s) being designed to optically detect the passage of the chemical compound(s) through the sensing arm.

### CROSS-REFERENCE TO RELATED APPLICATION

This application claims priority to foreign French patent application No. FR 2310040, filed on Sep. 22, 2023, the disclosure of which is incorporated by reference in its entirety.

### FIELD OF THE INVENTION

The present invention relates generally to the field of gas mixture analysis or gas sensor analysis, and in particular to a gas-phase analytical system comprising an optical detection device.

### BACKGROUND

In analytical systems of the gas-phase chromatography type, which make it possible to identify and quantify volatile chemical compounds, it is known to use conventional and/or miniaturized chromatography detectors such as, for example, mass spectroscopy devices, flame ionization detectors (FIDs), nanoelectromechanical devices or NEMS, or micro thermal conductivity detectors. Some gas-phase analytical systems comprise devices for integrated optical detection. Such solutions are described, for example, in the articles “A microfabricated optofluidic ring resonator for sensitive, high-speed detection of volatile organic compounds” by Kee Scholten et al., Lab Chip, 2014, 14, 3873, “A Portable Micro-Gas Chromatography with Integrated Photonic Crystal Slab Sensors on Chip” by Priyanka Biswas et al., Biosensors, 2021, 11, 326, or also “Fabry-Pérot Cavity Sensors for Multipoint On-Column Micro Gas Chromatography Detection” by Jing Liu et al., Analytical Chemistry, 2010, 82, 11, 4370-4375.

However, the known detection devices are expensive, are restricted in terms of their ability to detect specific chemical compounds, have a high detection limit, and/or have low detection versatility.

Some optical detection devices also require an advanced measurement environment coupled with an expensive detector. For example, some optical detection devices use a spectrally fine and tunable laser source in order to spectrally align with the resonant wavelength of the optical cavity of the detection device.

There is therefore a need for an improved gas-phase analytical system.

### SUMMARY OF THE INVENTION

The invention improves the situation by proposing a gas-phase analytical system comprising an injection unit configured to inject a sample to be analyzed comprising at least one chemical compound, a unit for introducing a stream of carrier gas, a transport column, and a detection device, the at least one chemical compound being entrained by the carrier gas into the transport column up to the detection device. The detection device is an optical detector comprising at least one Mach-Zehnder interferometric sensor supplied by an optical source and integrated into a microfluidic structure, the sensor comprising a sensing arm exposed to the at least one chemical compound and a reference arm impermeable to the at least one chemical compound, the at least one sensor being designed to optically detect the passage of the at least one chemical compound through the sensing arm. The microfluidic structure comprises a primary microfluidic channel and/or at least one secondary microfluidic channel sealed at the channel end, the at least one chemical compound being transported by convection through the primary channel and/or by diffusion through the sealed secondary channel, the at least one sensor being positioned on the primary channel and/or the sealed secondary channel, the detection device being designed to determine the retention time and/or the coefficient of diffusion of the at least one chemical compound at the outlet of the column on the basis of the optical detection of the passage of the at least one chemical compound through the sensor.

Advantageously, the at least one Mach-Zehnder interferometric sensor may comprise a coating on the sensing arm, the coating being adapted to preferentially adsorb the at least one chemical compound.

In some embodiments, each sealed secondary microfluidic channel may have a distinct channel length L defined in the direction of movement of the at least one chemical compound.

The at least one sealed secondary microfluidic channel may comprise at least one physical obstacle locally disposed in the channel, the obstacle being designed to minimize any convective phenomenon at the inlet of the channel and/or to slow down the phenomenon of diffusion of the chemical compound to be detected.

According to some embodiments, the microfluidic structure may further comprise at least one secondary microfluidic channel open at the channel end, the at least one chemical compound being transported by convection through the open secondary microfluidic channel.

The at least one open and/or sealed secondary microfluidic channel may comprise a coating comprising a physicochemical substance on the wall of the channel.

The invention also provides a method for analyzing a sample comprising at least one chemical compound, the method comprising at least the following steps:
injecting the sample to be analyzed into the gas-phase analytical system;
acquiring at least one optical measurement signal detected by at least one Mach-Zehnder interferometric sensor of the gas-phase analytical system;
associating, with the at least one optical measurement signal, a chemical compound of the sample to be analyzed.

The method further comprises a step of determining a retention time value and/or a diffusion time value relating to the chemical compound associated with the at least one optical measurement signal.

The embodiments of the invention thus provide an improved gas-phase analytical system comprising a miniaturized detector that enables improved selectivity of chemical compounds to be analyzed, with a low detection limit, low cost, and which is fast and compatible with any carrier gas.

The gas-phase analytical system and the associated method, according to the embodiments of the invention, make it possible on the one hand to detect the passage of one or more gaseous chemical compounds spatially separated beforehand by a chromatography column, and on the other hand to provide specific information on the nature of the or these gaseous chemical compound(s).

They also allow an implementation that is compatible with any type of carrier gas, a wide range of detection with respect to the nature of the gaseous chemical compounds detected (i.e. alkanes, alcohols, acetone, esters, etc.), non-destructive detection of the gaseous compounds to be analyzed, and also a low limit of detection of gaseous chemical compounds typically for concentrations of less than a few hundred ppb (or “parts per billion”, corresponding to a ratio of 10-9).

They also make it possible to provide a solution with increased compactness, which is compatible with high-frequency measurement acquisition (i.e. in particular between 240-1000 Hz), and to limit the effects of drift over time of the measurements associated, for example, with fluctuations in temperature, flow, pressure, or laser wavelength.

The embodiments of the invention advantageously provide an affordable solution in terms of cost, the manufacture of the gas-phase analytical system being in particular compatible with collective manufacture in a clean room and with the use of inexpensive detection electronics.

### BRIEF DESCRIPTION OF THE DRAWINGS

Other features, details and advantages of the invention will become apparent on reading the description given with reference to the appended drawings, which are given by way of example.

FIG. 1 is a diagram showing a gas-phase analytical system, according to some embodiments of the invention.

FIG. 2 is a diagram showing an optical detection device, according to some embodiments of the invention.

FIG. 3 is a diagram showing an optical detection device, according to some embodiments of the invention.

FIG. 4 is a diagram showing an optical detection device, according to some embodiments of the invention.

FIG. 5 is a diagram showing a schematic view of a Mach-Zehnder interferometric sensor, according to some embodiments of the invention.

FIG. 6 is a diagram showing a cross-sectional plane through a Mach-Zehnder interferometric sensor, according to some embodiments of the invention.

FIG. 7 consists of four graphs (a), (b), (c) and (d) illustrating results of analysis of chemical compounds by the gas-phase analytical system, according to some embodiments of the invention.

FIG. 8 is a photograph taken by scanning electron microscopy illustrating a Mach-Zehnder interferometric sensor, according to some embodiments of the invention.

FIG. 9 is a diagram showing an optical detection device, according to some embodiments of the invention.

FIG. 10 consists of two graphs (a) and (b) respectively illustrating the evolution of a diffusion time t and of a detection separation time δτ between two diffusion times as a function of the length L of a secondary microfluidic channel, according to some embodiments of the invention.

FIG. 11 is a diagram showing a detection device, according to some embodiments of the invention.

FIG. 12 is a flow diagram showing a method for analyzing a sample with a gas-phase analytical system, according to some embodiments of the invention.

Identical references are used in the figures to denote identical or similar elements. For the sake of clarity, the elements that are shown are not to scale.

### DETAILED DESCRIPTION

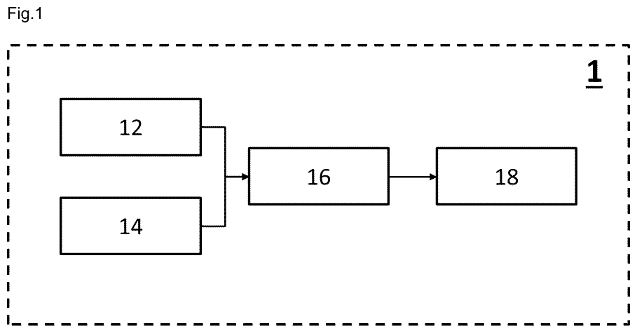

FIG. 1 schematically represents a gas-phase analytical system 1 (also called an “analytical system”) comprising an injection unit 12 configured to inject a sample to be analyzed, a unit 14 for introducing a stream of carrier gas, a transport column 16, the injected sample being entrained by the carrier gas into the transport column and a detection device 18, according to some embodiments of the invention.

Such a sample to be analyzed comprises a chemical compound (that is to say a type of molecule, a chemical species or an analyte) or a mixture of chemical compounds to be identified and/or quantified by the analytical system 1.

The analytical system 1 can be used in various fields of gas mixture analysis or gas sensor analysis, for example for industrial, security or defense, health, energy or environmental applications.

The injection unit 12 may be associated, for example, with a manual or automatic injection microsyringe containing the sample to be injected into the analytical system 1.

Once injected into the analytical system 1, the sample to be analyzed (in the liquid phase or in the gas phase) is entrained by a carrier gas, through the column 16 which contains an active substance called the stationary phase. The carrier gas, constituting a mobile phase for the chemical compound(s), may for example be helium, dihydrogen, compressed air, or dinitrogen maintained at 1 bar in the introduction unit 14. The unit for introducing a stream of carrier gas may therefore be configured to contain and regulate the introduction of a controlled stream of carrier gas into the analytical system 1. The unit 14 may for example comprise a pressure reducer/regulator. In addition, the then gaseous compounds of the sample may be entrained into the column 16 by pumping and valve units (not shown in the figures). The transport column 16 may be what is known as a capillary chromatography column or a silicon microchannel, for example. The column 16 and a portion at least of the injection unit 12 may be placed in a thermostatically controlled enclosure (also not shown in the figures), the applied temperature of which is adapted to the volatility of the chemical compound(s) of the sample to be analyzed.

The column 16 is characterized by a predefined length. For example, and without limitations, this length may be equal to 3 meters. The various gaseous compound(s) pass through the column 16 at a specific speed predefined by their physicochemical affinity with the stationary phase. As used herein, the term “physicochemical affinity”, also called “physicochemical compatibility” or “physicochemical similarity”, is associated with all of the physicochemical interactions between the analytes of the sample and the elements of the analytical system 1. In particular, in relation to column 16, the term “physicochemical affinity” refers to all of the physicochemical interactions between analytes passing through the transport column and the active substance of the stationary phase thus impacting the elution rate of the analytes in the column. Thus, a gaseous compound passes through the column 16 according to a time defined as a function of the length of the column and the physicochemical affinity of this compound with the stationary phase of the column. This time for passing through the column 16, also called the “retention time” or “elution time”, thus represents the time elapsed between the injection of the compound into the analytical system 1 and its exit from the column 16.

In the case of a sample comprising a mixture of chemical compounds each having a distinct physicochemical affinity with the stationary phase, each compound of the mixture is associated with a distinct speed of movement in the column 16. The various chemical compounds thus separate spatially along the column 16 and leave the column 16 one after the other, according to a distinct retention time.

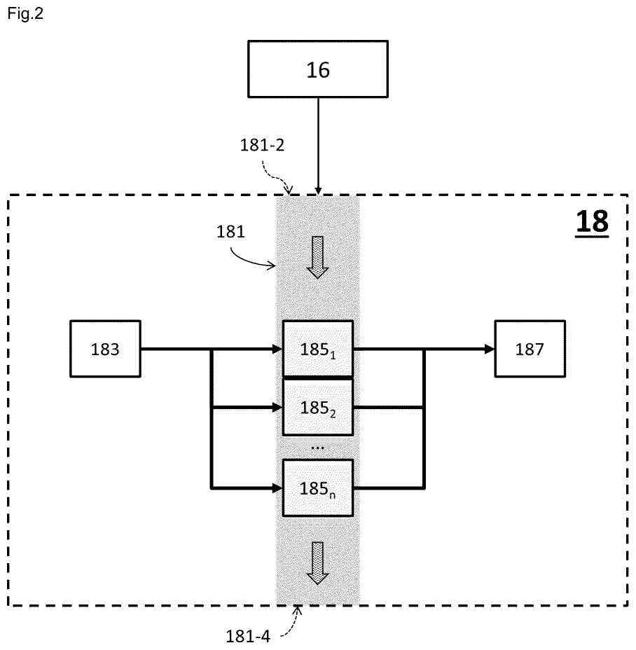

As shown in FIG. 2, the detection device 18 is connected to the column 16 via a device inlet 181-2, associated with a microfluidic structure, through which the chemical compound(s) to be analyzed are transferred.

The microfluidic structure may comprise a primary microfluidic channel 181 through which the chemical compound(s) are transported by convection from the device inlet 181-2 up to a device outlet 181-4.

The detection device 18 further comprises an optical source 183, one or more Mach-Zehnder interferometric sensors 185 (also called “measurement sensor” or “sensor”), and an optical detection and processing unit 187. A Mach-Zehnder interferometric sensor 185 is integrated into the microfluidic structure and connected and optically operated by the optical source 183.

In some embodiments, the Mach-Zehnder interferometric sensor(s) 185 may be positioned at the primary microfluidic channel 181. For example and without limitations, the detection device 18 may comprise N measurement sensors 185ₙ positioned at the primary microfluidic channel 181, as shown in FIG. 2. The number N of sensors may be, for example, a positive integer greater than or equal to 1. The parameter “n” denotes an index associated with a sensor of the detection device and is an integer between 1 and N. In this case, each Mach-Zehnder interferometric sensor 185ₙ is configured to optically detect the passage of one or more gaseous chemical compounds of the sample (spatially separated beforehand by a column 16), transported by convection and passing through the sensor 185ₙ. The detection of the passage of at least one compound consists in performing an optical measurement of the retention time value of at least one compound of the sample transported by convection and passing through the sensor 185ₙ. The optical detection and processing unit 187 of the detection device 18, which unit is connected to the measurement sensor(s) 185ₙ as shown in FIG. 2, may thus be designed to collect the optical detection (or measurement) signals, and determine the retention time of at least one compound of the sample at the outlet of the column 16 on the basis of the optical measurements of the sensors.

It should be noted that, in such a primary microfluidic channel 181, the Mach-Zehnder interferometric sensors 185ₙ may be configured to simultaneously (i.e. substantially at the same time) detect the passage of a specific compound. Thus, for such a detection device 18, the time axis associated with the numerical evaluation of the retention time value of the transported compound(s) of the sample is advantageously identical for each sensor 185ₙ. The origin (i.e. the zero) of such a single time axis may in particular correspond to the instant of injection of the sample to be analyzed (at the inlet of the transport column 16). The retention time value of an analyte then corresponds to the time between the associated detection peak of any analyte and the origin with respect to the single time axis of the detection device 18.

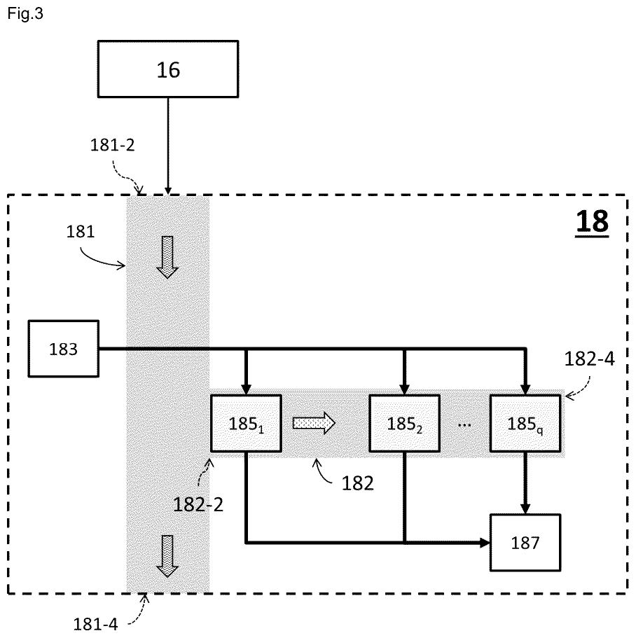

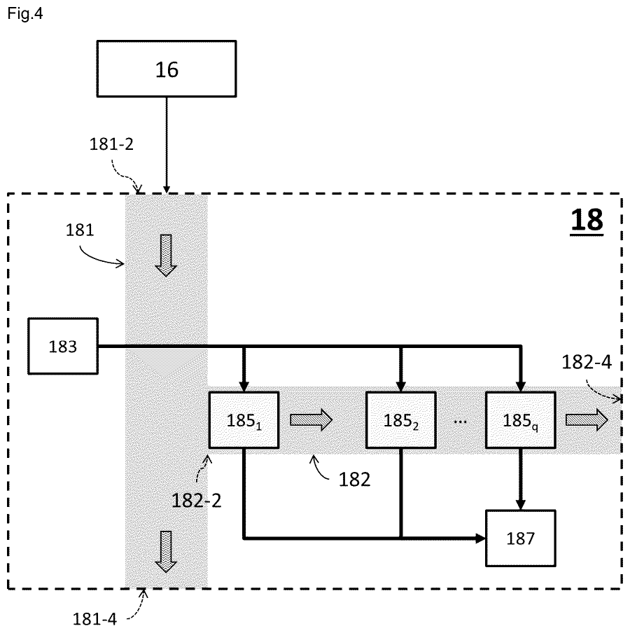

In some embodiments, as illustrated in FIG. 3, the microfluidic structure may also comprise a secondary microfluidic channel 182 fluidically connected to the primary microfluidic channel 181 via an entrance 182-2 and extending to a channel termination 182-4. The Mach-Zehnder interferometric sensor(s) 185 may be positioned at the secondary microfluidic channel 182. For example and without limitations, the detection device 18 comprises Q Mach-Zehnder interferometric sensors 185_{q} positioned at the secondary microfluidic channel 182, as shown in FIGS. 3 and 4. The number Q of sensors may be, for example, a positive integer greater than or equal to 1. The parameter “q” denotes an index associated with a sensor of the detection device and is an integer between 1 and Q.

Advantageously, the channel termination 182-4 may be sealed (or closed) as shown in FIG. 3. In this case, the chemical compound(s) to be analyzed are transported through the secondary microfluidic channel 182 by diffusion. Each Mach-Zehnder interferometric sensor 185_{q} is thus configured to optically detect the passage of one or more gaseous chemical compounds of the sample, transported by diffusion and passing through the sensor 185_{q}. The detection of the passage of compound(s) consists in performing an optical measurement of the “relative diffusion time” value of at least one compound of the sample transported by diffusion and passing through the sensor(s) 185_{q}. The optical detection and processing unit 187 of the detection device 18, which unit is connected to the measurement sensor(s) 185_{q}, may thus be designed to collect the optical measurement signals and determine the diffusion time of at least one compound of the sample transported through the secondary microfluidic channel 182 on the basis of the optical measurements of the sensors.

It should be noted that the relative diffusion time value measured by a sensor depends on the diffusion rate of the compound.

In some embodiments, the coefficient of diffusion of a compound (or rate of diffusion in the microfluidic channel) may be determined as a function of the relative diffusion time value optically measured by a sensor 185_{q} positioned at the channel termination (that is to say at the end) 182-4 and of the position of the measurement sensor 185_{q} in this channel. The coefficient of diffusion of a compound may be adjusted by additionally taking into account the optical measurement of at least one sensor positioned at the primary microfluidic channel 181 (sensor 185ₙ), that is to say by taking into account the relative retention time value by the sensor. The coefficient of diffusion of a compound may also be adjusted by additionally taking into account the optical measurement of a sensor positioned, for example, at the entrance 182-2 at the inlet of the secondary microfluidic channel 182 (sensor 185g).

Alternatively, the termination (or end) of the channel 182-4 may be open, as shown in FIG. 4. In this case, as for the primary microfluidic channel 181, the chemical compound(s) to be analyzed are transported through the secondary microfluidic channel 182 (i.e. forming a so-called “through” channel) by convection, and the Mach-Zehnder interferometric sensor(s) 185 positioned at the channel 182 are configured to optically measure the retention time value of at least one compound of the sample transported by convection and passing through the sensor(s) 185.

The detection device 18 which comprises one or more secondary microfluidic channels 182 with an open termination 182-4 makes it possible in particular to increase the number of Mach-Zehnder interferometric sensors 185 in the analytical system 1, as well as to address them (that is to say to optically interrogate them) simultaneously. Such a configuration of the device 18 also makes it possible to regulate (or adjust) the transport rate of the analysts at each sensor of the device 18. Such an adjustment may be carried out, in particular passively, by design and/or manufacture of the microfluidic channels and in accordance with certain sensors for example to determine the optimal rate of transport of the analytes through the various (secondary and/or primary) microfluidic channels.

In addition, the detection device 18 may comprise a functionalization of the wall of such a secondary microfluidic channel 182 having an open and/or closed channel termination.

As used herein, the term “functionalization” refers to a coating (called a layer or also a deposit) comprising one or more chemical species and/or a physicochemical substance, on an element of the microfluidic structure and/or on an element of a Mach-Zehnder interferometric sensor of the detection device 18, so as to produce physicochemical properties specific to this element.

In particular, the functionalization of the wall (that is to say of the internal wall) of such a secondary microfluidic channel 182, in some embodiments of the invention, corresponds to a coating of a physicochemical substance (or stationary phase) on the wall of the channel. Such a substance may be adapted to retain (i.e. adsorb) certain specific analytes according to its physicochemical affinity with the chemical compounds to be analyzed. The analytes referred to as “retained” by the physicochemical substance of the wall are then associated with a retention time value, in the functionalized secondary microfluidic channel 182, which is greater than the retention time values of the “unretained” analytes.

It should be noted that the active substance (i.e. stationary phase) of the transport column 16 corresponds to a type of functionalization of the internal wall of this chromatography column.

Advantageously, the functionalization of the wall of the secondary microfluidic channel 182 may be different from the functionalization of the transport column 16, thus generating a chromatography dimension that is distinct from the chromatography dimension relating to the chromatography column.

For example and without limitation, the secondary microfluidic channel 182 having an open channel termination may then correspond to a chromatographic measurement channel. Such a “2D” (i.e. two-dimensional or comprising two dimensions) chromatography system resulting from the coupling of the results of two chromatographic separations of different nature (transport column 16 and secondary microfluidic channel 182) makes it possible to improve the analysis of complex mixtures of chemical compounds to be separated and having substantially similar physicochemical affinities. In particular, such a 2D chromatography system makes it possible to separate compounds through the secondary microfluidic channel 182 which have not been separated beforehand through the chromatography transport column 16. A 2D chromatography system using at least two chromatographic separations with stationary phases having opposite physicochemical properties makes it possible in particular to verify or monitor any crossovers (or overlaps) between detection peaks. For example and without limitations, the analytical system 1 may comprise a “polar” transport column 16 and a “non-polar” secondary microfluidic channel 182. In this case, a “polar” compound may be associated with a retention time value, obtained at the outlet of the polar column 16, which is greater than the retention time value of a “non-polar” compound. The same polar compound may then be associated with a retention time value, obtained at the end of the non-polar channel 182, which is smaller than or similar to the retention time value of the non-polar compound. The use of channels comprising Mach-Zehnder interferometric sensors 185 for a 2D chromatography system allows for fast measurement and optimized real-time monitoring of the detection measurements, even over small dimensions of channels 181 and 182.

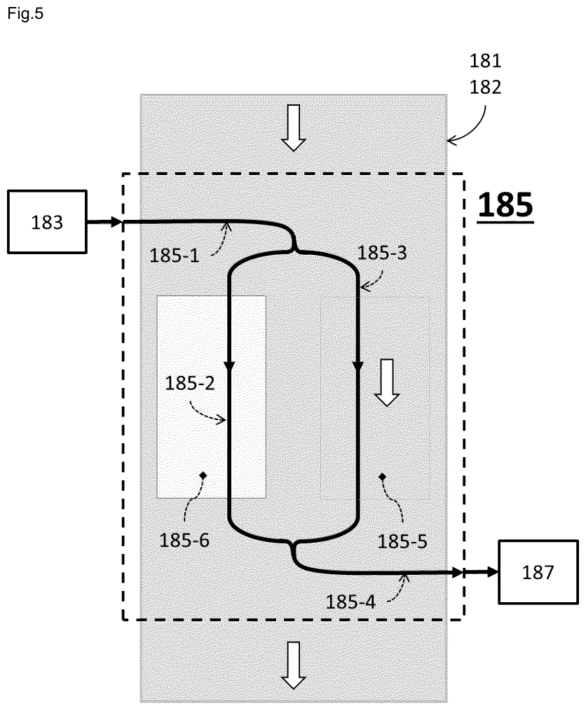

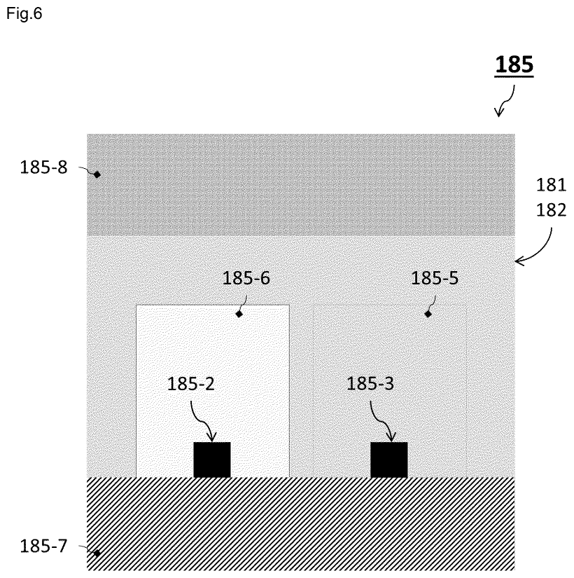

FIG. 5 and FIG. 6 respectively show a schematic view and a cross-sectional view of a Mach-Zehnder interferometric sensor 185 (i.e. sensor 185ₙ or 185_{q}). The Mach-Zehnder interferometric sensor 185 is supplied (or implemented) by the optical source 183 designed to produce electromagnetic radiation (also called “optical signal”). For example and without limitations, the optical source 183 may be a visible or near-infrared laser or diode configured to emit a beam at a wavelength of 800 nm, 1310 nm or 1550 nm. The emission wavelength of the optical source 183 may alternatively be greater than 3 μm for example.

The initial optical signal coming from the optical source 183 propagates initially in free space or in an optical fiber coupled to a first coupling waveguide 185-1 of the Mach-Zehnder interferometric sensor 185. The initial optical signal is thus directed towards a directional beam splitter, as shown in FIG. 5. Such a splitter may be a symmetrical optical coupler of 50/50 type (for example of fibered Y-configuration).

The directional splitter is configured to separate the initial optical signal transmitted by the optical source 183 via the first coupling waveguide 185-1 into a reference component of the signal and a measurement component of the signal, propagating respectively towards a reference waveguide 185-2 (also called “reference arm”) and a measurement waveguide 185-3 (also called “sensing arm”).

The two components of the signal transmitted through the reference arm 185-2 and the sensing arm 185-3 are then directed to a directional beam combiner configured to recombine them on a second coupling waveguide 185-4 (i.e. on a single optical path) into an optical measurement signal. Such a combiner may also be a 50/50-type fibered Y symmetrical optical coupler.

The optical measurement signal is thus directed to the optical detection and processing unit 187 via a waveguide, coupling in an optical fiber or by propagation in free space. In particular, the optical detection and processing unit 187 is designed to detect the optical measurement signal so as to generate a signal representative of the evolution over time of the detected light intensity resulting from the interference between the reference component of the signal and the measurement component of the signal. For example and without limitations, the unit 187 may comprise at least one photodiode.

While the sensing arm 185-3 of the Mach-Zehnder interferometric sensor 185 is exposed to the chemical compound(s) to be analyzed transported in the exposure environment 185-5, the reference arm 185-2 of the Mach-Zehnder interferometric sensor 185 is encapsulated by means of an encapsulation layer 185-6 that is impermeable to the chemical compound(s) to be analyzed.

The exposure environment 185-5 corresponds to the primary microfluidic channel 181 or to the secondary microfluidic channel 182 at the sensor 185. In other words, the microfluidic channel 181 or 182 passes through the Mach-Zehnder interferometric sensor(s) 185. For example and without limitations, the first coupling waveguide 185-1, the reference arm 185-2 encapsulated in the encapsulation layer 185-6, the sensing arm 185-3 and the second coupling waveguide 185-4 may be positioned in the microfluidic channel 181 or 182, as shown in FIGS. 5 and 6. In other examples, it is possible for only the sensing arm 185-3 to be positioned in the microfluidic channel 181 or 182, which is then narrower than the sensor 185.

During their passage by convection or by diffusion through the exposure environment 185-5 (i.e. through the microfluidic channel 181 or 182), the chemical compound(s) to be analyzed induce a change in the local refractive index perceived by the evanescent part of the electromagnetic field of the measurement component of the signal propagating in the measurement waveguide 185-3, inducing a temporary change in its effective optical index. At the same time, the encapsulation layer 185-6 is configured so that the reference waveguide 185-2 does not undergo any change in its effective index, in particular when an analyte passes through the sensor 185, with the propagation of the reference component of the signal not being affected. The encapsulation layer 185-6 may, for example, be a silicon dioxide coating.

Those skilled in the art will understand that the material design and the manufacture of the Mach-Zehnder interferometric sensor 185 depends on the nature and the wavelength of the beam used, emitted by the optical source 183, for implementing the photonic-optical sensor. Similarly, the optical detection and processing unit 187 may be chosen and designed to collect the optical measurement signals at the output of the sensors 185 (that is to say in particular according to the wavelength, the power of the signals, the frequency, etc.).

It should be noted that the change in effective optical index which occurs in the sensing arm 185-3 results in a phase shift between the reference component of the signal and the measurement component of the signal, which induces the interference signal measurable by the optical detection and processing unit 187. Since the change in the effective optical index of the measurement waveguide 185-3 is determined in particular as a function of the amount of molecules adsorbed, the amplitude of such a change in index may be, to a first approximation, proportional to the concentration of the same chemical compound to be analyzed passing through the exposure environment 185-5.

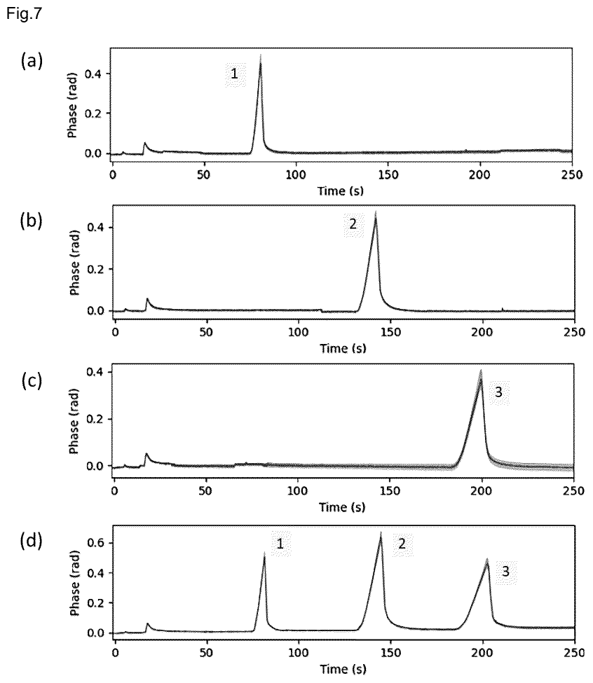

FIG. 7 shows examples of graphs illustrating results of analysis of chemical compounds by the optical detection and processing unit 187 of the analytical system 1. In particular, FIG. 7 shows what are known as chromatographic detection peaks corresponding to the detection of specific chemical compounds by one or more Mach-Zehnder interferometric sensors 185. These detection peaks are associated on the abscissa with retention times determined for the chemical compounds detected: a heptane compound (C7, peak no. 1 in FIG. 7), a toluene compound (peak no. 2) and an octane compound (C8, peak no. 3), initially prepared in a 1 mL solution of mineral oil solvent, separately (graphs (a), (b) and (c) of FIG. 7) or in a mixture (graph (d) of FIG. 7).

The set of waveguides of the Mach-Zehnder interferometric sensor 185, forming the integrated optical circuit of the sensor, may be positioned on a support layer (or substrate layer) 183-7 consisting, for example, of a silicon layer (or “silicon wafer”) and a silicon dioxide layer, also called “thermal SiO₂ BOX”. Such an integrated optical circuit also comprises a cover layer 183-8 as shown in FIG. 6. For example and without limitations, the cover layer 183-8 may consist of a layer of silicon or a layer of glass, etched to form the microfluidic channel passing through the sensor 185, and bonded by a bonding process such as a screen printing process or an anodic bonding process.

In some embodiments, the sensing arm 185-3 and the reference arm 185-2 may consist of a straight waveguide as shown in FIG. 5, or consist of several straight waveguide segments defined along the axis of the channel and connected by curved waveguide segments (or bends) not shown in the figures.

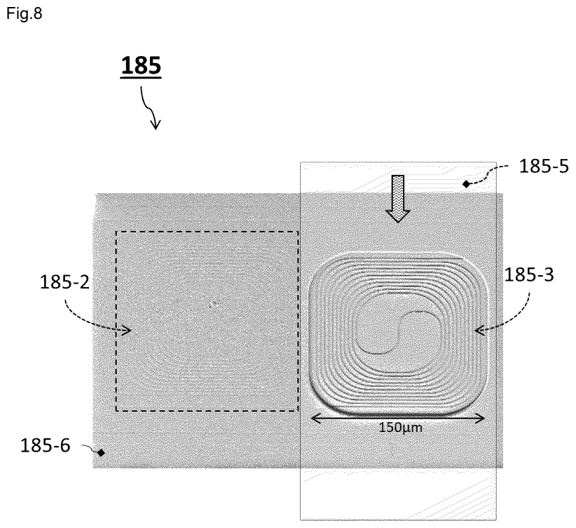

In other embodiments, the sensing arm 185-3 and the reference arm 185-2 may be spiral waveguides with a square envelope as shown in FIG. 8, a circular or elliptical envelope, or a rectangular envelope defined along the axis of the channel (not shown in the figures).

A spiral arm configuration or one comprising multiple straight waveguide segments enables a long arm length and thus high sensitivity associated with the sensing arm 185-3. In addition, a spiral configuration with a square envelope may be advantageously used in a Mach-Zehnder interferometric sensor 185 positioned at a secondary microfluidic channel 182 since it makes it possible to obtain a compact sensor suitable for the point measurement of diffusion times.

Advantageously, a Mach-Zehnder interferometric sensor 185 may comprise a functionalization of the sensing arm 185-3 so as to modulate the sensitivity of the arm according to the physicochemical properties of the chemical compounds to be analyzed.

In particular, the functionalization (or functionalization layer) of the sensing arm 185-3 of a Mach-Zehnder interferometric sensor (185ₙ and/or 185_{q}), in some embodiments of the invention, corresponds to a coating of one or more chemical species on (i.e. covering) the surface of the waveguide of the measurement sensing arm. Such a functionalization layer may be adapted to preferentially adsorb one or more of the specific chemical compounds passing through the exposure environment 185-5, which enables better detection of the targeted compound(s). In particular, the functionalization layer makes it possible to obtain specific information additional to that already obtained by virtue of the chromatography column. In particular, the functionalization layer increases the capacity of the system to specifically identify compounds, even if the latter are only separated to a slight extent by the chromatography column.

Advantageously, a large number N and/or Q of Mach-Zehnder interferometric sensors (185ₙ and/or 185_{q}), comprising different functionalizations in particular, makes it possible to determine a large number of different items of information relating to each detected compound of the sample to be analyzed. For example and without limitation, for each compound denoted Cᵢ of the sample to be analyzed, the detection of the compound by a sensor (185ₙ and/or 185_{q}) is associated with a score value (i.e. of parameter or weight) determined from one or more quantities relating to the detection peak (i.e. to the measurement signal) of the sensor under consideration for this compound. Such a score value, denoted sᵢₙ and/or s_{iq}, may be determined from the height of the peak (i.e. value of the peak along the y-axis in FIG. 7 for example), and/or from the width of the peak at half height, area of the peak, shape of the peak, etc., or more generally any measurement associated with the peak of the measurement signal obtained from the sensor 185 and relating to the adsorption and/or desorption of the analyte by this sensor. Each determined score value (sᵢₙ and/or s_{iq}) then corresponds to an additional item of information on a compound Cᵢ of the sample to be analyzed (relating to a given retention time provided by the column 16 and/or a diffusion time) given by a sensor (185ₙ and/or 185g) that is precise and characteristic of a specific physicochemical property. Thus, the set denoted Sᵢ of the score values of a compound Cᵢ forms the physicochemical signature of this compound through the detection device 18. The signature Sᵢ, which is unique for each compound Cᵢ to be analyzed, may therefore be written according to the expression (01) below:

Sᵢ={sᵢ₁, . . . ,s_{iN} and/or s_{iQ}} (01)

The evaluation of a signature Sᵢ thus makes it possible to effectively determine the nature of the compound Cᵢ. Such an evaluation can be carried out on the basis of the comparison of the different score values of the compound Cᵢ for example, and in particular by taking into account a comparison with other score values relating to other compounds or an analysis according to such values.

The use of the signatures S enables the more robust identification of the compounds of the sample compared to a simple estimation from diffusion times and/or retention times, these times possibly proving to be similar for several compounds to be distinguished.

By way of example, the functionalization (or functionalization layer) of the sensing arm 185-3 of a Mach-Zehnder interferometric sensor (185ₙ and/or 185_{q}) may correspond to a “polar” functionalization adapted to increase the detection sensitivity of the sensing arm 185-3 to polar compounds and reduce the sensitivity to non-polar compounds. Chemistries of greater or lesser polarities associated with distinct measurement sensors 185 induce a greater or lesser physicochemical affinity with such specific gaseous analytes according to their polarity. This induces variations in optical intensity/phase at the sensing arm 185-3 that are more or less significant depending on the sensor 185ₙ or 185_{q} involved. The variations in optical response between a plurality of differently functionalized sensors are quantifiable and allow the specific analyte to be placed on a polarity scale.

For example and without limitations, a functionalization layer deposited on the measurement waveguide 185-3 may consist of a thin-film deposition by sputtering, one or more chemical vapor depositions which may be combined with a plasma treatment, a layer obtained by grafting used for example in chromatography for the functionalization of stationary phases, or else a layer obtained by liquid-phase grafting of biomolecules by deposition of microdroplets as described, for example, in the articles “A silicon photonic olfactory sensor based on an array of 64 biofunctionalized Mach-Zehnder interferometers” by Laplatine, L. et al., Optics Express 30 (19), 33955-33968 (2022).

In addition, each Mach-Zehnder interferometric sensor 185 (i.e. sensor 185ₙ and/or 185_{q}) may comprise a particular functionalization associated with one of the different chemical compounds to be detected by convection and/or by diffusion. The chromatographic peaks obtained at the unit 187 can make it possible to characterize the ratio of the responses of the sensors 185 associated with different polarity chemistries.

It should be noted that the primary microfluidic channel 181 and/or the secondary microfluidic channel 182 of the detection device 18 may be characterized by a fluidic cavity volume sufficiently small as to avoid widening of the detection peaks obtained at the unit 187. Typically, such a fluidic cavity volume may be less than one microliter (L). A microfluidic channel may, for example, be represented by a cavity having a height of 200 μm and a width of 400 μm, in the cross-sectional plane of the cavity perpendicular to the direction of propagation (i.e. convection) of the compounds. The microfluidic channel may also be represented by a cavity having a height of 200 μm and a width of 200 μm, in the embodiment in which only the sensing arm 185-3 may be positioned in the microfluidic channel 181 or 182 which is in this case narrower than the sensor 185.

It should be noted that at the transition between the transport column 16 and the primary microfluidic channel 181, that is to say at the device inlet 181-2, the chemical compounds to be detected may undergo a reduction in the convection transport volume, called “dead volume”.

Moreover, a primary microfluidic channel 181 may be dimensioned for a channel length of 1 mm, in the direction of movement of the compounds.

Advantageously, the detection device 18, and in particular the microfluidic structure, may comprise a plurality of secondary microfluidic channels 182, each channel comprising a sensor 185_{q} positioned at the channel termination 182-4 and characterized by a distinct channel length, for example and without limitation of between 1 and 10 mm.

Such channel (181 and/or 182) lengths are compatible with the incorporation of a plurality of Mach-Zehnder interferometric sensors (185ₙ and/or 185g) with a typical unit area of sensing arm 185-3 of 200 μm by 200 μm.

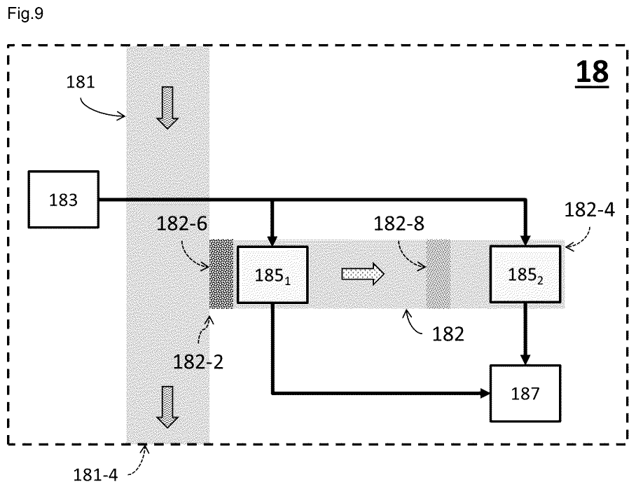

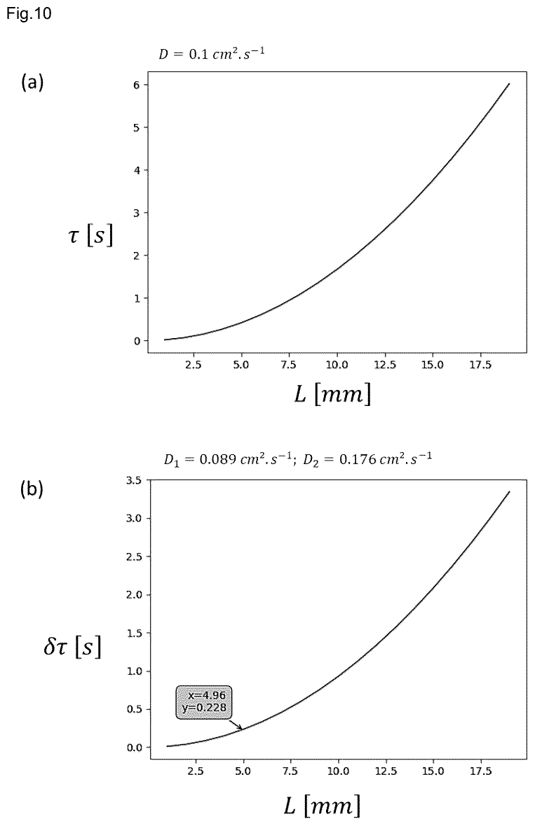

In some embodiments, two measurement sensors 185_{q} positioned respectively at the inlet (entrance 182-2) and at the outlet (termination 182-4) of the secondary microfluidic channel 182, as shown in FIG. 9, make it possible to determine the diffusion time t required for one or more chemical compounds to travel the length L of this channel 182 by diffusion. FIG. 10(a) illustrates the evolution of the diffusion time t as a function of the length L of a secondary microfluidic channel 182, obtained from equation (02) described below:

$$τ = \frac{1}{6} \times \frac{{L}^{2}}{D} \qquad ( 02 )$$

In equation (02), the parameter D corresponds to the coefficient of diffusion of a chemical compound to be detected. The value of D used in equation (02) can be calculated (using the Chapman-Enskog equation for example) or extracted from tables. For example and without limitations, the coefficient D may be equal to 0.1 cm²·s⁻¹, as in the example of FIG. 10(a). For an example of a length L of channel 182 of 3 mm, the necessary diffusion time t for a chemical compound having such a coefficient of diffusion is 150 ms. For an example of a length L of 10 mm, the diffusion time τ is 1.6 s. Such an architecture of the detection device 18 comprising one or more secondary microfluidic channels 182 therefore allows a chemical compound to have the time to diffuse in the secondary microfluidic channel 182 over a time less than the time needed for this compound to pass through the primary microfluidic channel 181, typically of several seconds. By using a plurality of secondary microfluidic channels 182 of different lengths L and/or with different functionalizations, it is possible to be able to address a wide range of coefficients of diffusion of the chemical compounds to be analyzed.

A detection separation time &t corresponds to the difference between diffusion times of two compounds detected for example by a sensor 185_{q}. For example, as shown in FIG. 10(b), for a length L of channel 182 of 5 mm, the detection separation &t between the detection of a benzene compound (with a value of coefficient of diffusion D₁=0.089 cm²·s⁻¹) and the detection of a formaldehyde compound (with a value of coefficient of diffusion D₂=0.176 cm²·s⁻¹) is about 200 ms. Such an architecture of detection device 18 comprising at least one secondary microfluidic channel 182 also makes it possible to detect two chemical compounds having relatively similar coefficients of diffusion.

Consequently, the optical detection and processing unit 187 of the detection device 18 can thus be designed to determine a specific item of information concerning the diffusivity (represented by the coefficient of diffusion) of at least one compound of the sample transported through a secondary microfluidic channel 182 on the basis of the determined diffusion time values of compounds and the channel geometry.

Advantageously, a secondary microfluidic channel 182 of the detection device 18 may comprise one or more “physical” micro-obstacles and/or nano-obstacles, arranged locally in the channel, as shown in FIG. 9. Such obstacles may for example be pillars 182-6 positioned at the entrance 182-2 of the channel so as to minimize any convective phenomenon at the inlet of the channel 182 and optimize the transport of the chemical compounds by diffusion specifically. Such obstacles may also be any other physical obstacle 182-8 positioned in the channel in order to slow down the phenomenon of diffusion of certain chemical compounds. Such a slowing down of diffusion possibly makes it possible to address a wider range of coefficients of diffusion of chemical compounds that would otherwise require an excessively long length L of diffusion channel 182, or to increase the detection separation time δτ between two chemical compounds with very similar diffusion coefficients. Channel obstacles may consist, for example and without limitations, of a silicon layer comprising a porous membrane. Channel obstacles may also consist of a thin porous silica layer, such as a porous silica matrix obtained by a sol-gel manufacturing process generated directly in the secondary microfluidic channel 182 during its manufacture or mechanically inserted post-manufacture.

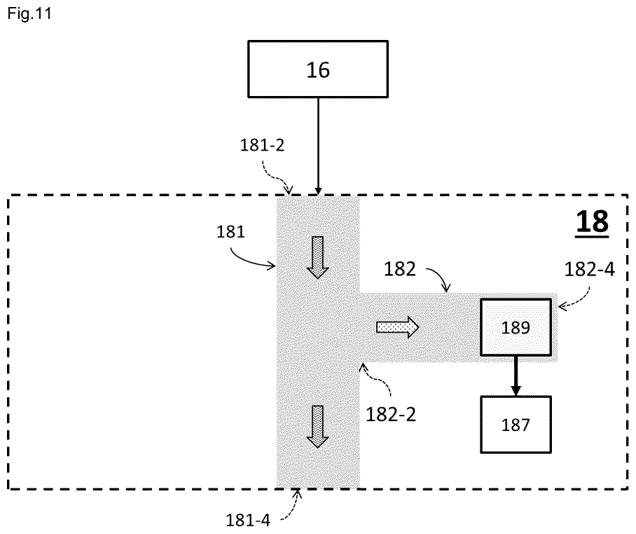

In some embodiments, the detection device 18, and in particular the microfluidic structure, may comprise at least one secondary microfluidic channel 182 the channel termination 182-4 of which is sealed such that the chemical compound(s) to be analyzed are transported by diffusion through the channel. The channel comprises one or more physical sensors 189 connected to the optical detection and processing unit 187. Advantageously, the channel 182 comprises a physical sensor 189 positioned at the termination (i.e. at the end) of the channel 182-4, as shown in FIG. 11. Such physical sensors 189 may be Mach-Zehnder interferometric sensors 185, and/or other types of physical sensors, such as, for example, micro thermal conductivity detectors (denoted μTCDs), capacitive micromachined ultrasonic transducers (denoted cMUTs), piezoelectric micromachined ultrasonic transducers (denoted pMUTs), ring resonators, Lamb wave pressure detectors, etc.

In some embodiments, the detection device 18 may comprise one or more reference sensors (not shown in the figures) configured to adjust, by calibration, the measurement values obtained by the optical detection and processing unit 187 from the optical measurement signals generated by the measurement sensors 185. Such a calibration makes it possible in particular to compensate for certain variations in parameters due to physical and environmental fluctuations that the gas-phase analytical system 1 might be subjected to, such as temperature fluctuations, pressure fluctuations during the injection of the sample to be analyzed, or laser wavelength fluctuations during data acquisition.

A reference sensor may, for example, correspond to a sensor of the Mach-Zehnder interferometric sensor type, the two interferometric arms (or interferometric waveguides) of which are either reference arms (impermeable to the chemical compound(s) to be analyzed) or sensing arms (exposed to the chemical compound(s) to be analyzed).

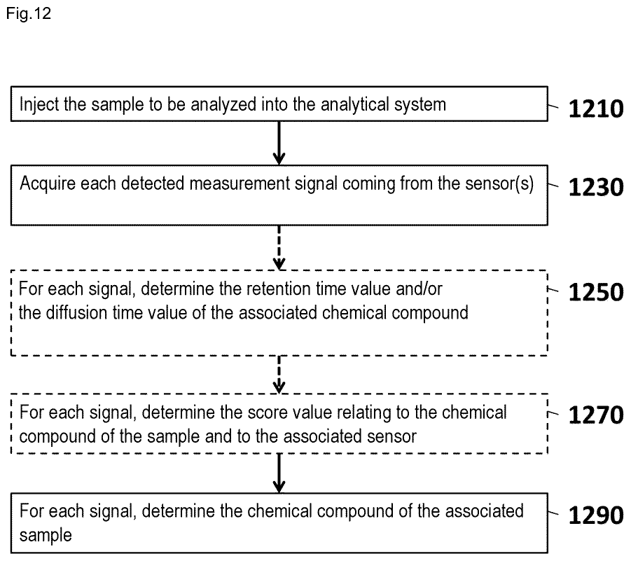

FIG. 12 shows the method for analyzing a sample comprising at least one chemical compound using a gas-phase analytical system 1, according to some embodiments of the invention.

The method comprises an initial step 1210 consisting in injecting the sample to be analyzed into the analytical system 1.

The chemical compound(s) transported in the column 16 then pass through the measurement sensor(s) 185, generating an optical measurement signal for each sensor and each detected chemical compound.

The method thus comprises an initial step 1230 of acquiring, by the optical detection and processing unit 187, each optical measurement signal coming from the measurement sensor(s) 185.

In step 1290, each detected optical measurement signal coming from the measurement sensor(s) 185 is associated with a chemical compound of the sample to be analyzed.

Advantageously, the method may further comprise a step 1250 of determining the retention time value and/or the diffusion time value relating to the chemical compound associated with each optical measurement signal.

In the case where the detection device 18 comprises a plurality of differently functionalized measurement sensors (185ₙ and/or 185_{q}), the method may also comprise a step 1270 of determining for each detected optical measurement signal (corresponding to a specific chemical compound Cᵢ and a particular sensor n and/or q) a score value (sᵢₙ and/or s_{iq}) relating to an additional item of information in order to form the signature Sᵢ of the compound. In this step, the evaluation of the signature Sᵢ of the chemical compound(s) Cᵢ to be analyzed may be carried out in order to determine the nature of these compounds.

In some embodiments, the method may comprise an additional step of calibrating the sensors with respect to the potential variations in environmental parameters on the basis of reference sensors positioned in the detection device 18.

Those skilled in the art will readily understand that certain steps of the method of FIG. 12 (in particular steps 1250 and 1270) can be carried out simultaneously, sequentially, independently or otherwise, and/or in a different order, for example in an order defined by the system 1 or the unit 187.

It should be noted that some features of the invention may have advantages when considered separately.

The device and the methods described above according to the embodiments of the invention or sub-elements of this system may be implemented in various ways using hardware, software or a combination of hardware and software, notably in the form of program code able to be distributed in the form of a program product, in various forms.

The invention is not limited to the embodiments described above by way of non-limiting example. It encompasses all variant embodiments that might be envisaged by those skilled in the art. In particular, those skilled in the art will understand that the invention is not limited to the various microfluidic channels, the various measurement sensors, or the various configurations of the detection device that have been described by way of non-limiting example. In particular, some embodiments of the invention may be combined.

1. A gas-phase analytical system comprising an injection unit configured to inject a sample to be analyzed comprising at least one chemical compound, a unit for introducing a stream of carrier gas, a transport column, and a detection device, said at least one chemical compound being entrained by the carrier gas into the transport column up to the detection device, wherein said detection device is an optical detector comprising at least one Mach-Zehnder interferometric sensor supplied by an optical source and integrated into a microfluidic structure, said sensor comprising a sensing arm exposed to said at least one chemical compound and a reference arm impermeable to said at least one chemical compound, said at least one sensor being designed to optically detect the passage of said at least one chemical compound through said sensing arm, said microfluidic structure comprising a primary microfluidic channel and/or at least one secondary microfluidic channel sealed at the channel end, said at least one chemical compound being transported by convection through the primary channel and/or by diffusion through the sealed secondary channel, said at least one sensor being positioned on said primary channel and/or said sealed secondary channel, said detection device being designed to determine the retention time and/or the coefficient of diffusion of said at least one chemical compound at the outlet of the column on the basis of the optical detection of the passage of said at least one chemical compound through said sensor.

2. The analytical system as claimed in claim 1, wherein said at least one Mach-Zehnder interferometric sensor comprises a coating on said sensing arm, said coating being adapted to preferentially adsorb said at least one chemical compound.

3. The analytical system as claimed in claim 1, wherein each sealed secondary microfluidic channel has a distinct channel length L defined in the direction of movement of said at least one chemical compound.

4. The analytical system as claimed in claim 1, wherein said at least one sealed secondary microfluidic channel comprises at least one physical obstacle locally disposed in said channel, said obstacle being designed to minimize any convective phenomenon at the inlet of said channel and/or to slow down the phenomenon of diffusion of said chemical compound to be detected.

5. The analytical system as claimed in claim 1, wherein the microfluidic structure further comprises at least one secondary microfluidic channel open at the channel end, said at least one chemical compound being transported by convection through the open secondary microfluidic channel.

6. The analytical system as claimed in claim 1, wherein said at least one open and/or sealed secondary microfluidic channel comprises a coating comprising a physicochemical substance on the wall of the channel.

7. A method for analyzing a sample comprising at least one chemical compound, the method comprising at least the following steps:
injecting the sample to be analyzed into the gas-phase analytical system as claimed in claim 1;
acquiring at least one optical measurement signal detected by at least one Mach-Zehnder interferometric sensor of said gas-phase analytical system;
associating, with said at least one optical measurement signal, a chemical compound of the sample to be analyzed,
the method further comprising a step of determining a retention time value and/or a diffusion time value relating to the chemical compound associated with said at least one optical measurement signal.
